(19) United States
(12) Patent Application Publication
(10) Pub. No.: US 2012/0100943 A1
(43) Pub. Date: Apr. 26, 2012

(54) PULLEY FOR BELT TRANSMISSION DEVICE, NOTABLY FOR A BELT SPEED-VARIATOR, AND BELT SPEED-VARIATOR INCORPORATING SUCH A PULLEY

(75) Inventor: Robert BLANCHARD, Le Boupere (FR)

(73) Assignee: FRANCE REDUCTEURS, LES HERBIERS (FR)

(21) Appl. No.: 13/274,882

(22) Filed: Oct. 17, 2011

(30) Foreign Application Priority Data
Oct. 25, 2010 (FR) 10 58725

(51) Int. Cl. F16H 55/56

(52) U.S. Cl. 474/8

(57) ABSTRACT

A pulley for a belt transmission device of the type including at least one shaft and two flanges supported by the shaft, one of the flanges, recessed centrally and received so as to fit onto the shaft for an axially free installation being fitted with return elements to return in the direction of the other flange, and delimiting with the other flange a groove of variable dimension inside which it is possible for the belt to be inserted, at least one of the flanges being a flange made of synthetic material furnished, on its surface facing the other flange, with a centrally recessed dish made of metal. The or each dish is, in its zone adjacent to the central recess, separated from the flange that it lines by a space, called a peripheral space, which reduces in the zone the thermal exchanges between flange and dish.

The present invention relates to a pulley for a belt transmission device, notably for a belt speed-variator, and a belt speed-variator incorporating such a pulley

It relates more particularly to a pulley comprising at least one shaft and two flanges supported by the said shaft, one of the flanges, called a moveable flange, recessed centrally, and received so as to fit onto the said shaft, for an installation, axially free and preferably secured in rotation to the said shaft, being fitted with return means for returning in the direction of the other flange, and delimiting with the other flange a groove of variable dimension inside which the said transmission belt is capable of being inserted, at least one of the flanges being a flange made of synthetic material furnished, on its surface facing the other flange, with a lining made of metal adopting the shape of a centrally recessed dish.

Speed variation is obtained by varying the winding diameter of the belt inside the groove. At maximum speed, on a speed-variator, a large winding diameter is observed on the drive pulley and a small winding diameter of the belt on the receiving pulley. On the receiving pulley, the transmission of the torque is limited by construction to a predetermined value. Beyond this torque value, a slipping of the belt is observed which causes heating which results in the destruction of the belt and, when the flanges are made of synthetic material, in damage to the flanges. In order to prevent such damage to the flanges, flanges made of metal are used. However, the ideal is to be able to use a flange made of synthetic material lined with metal, which provides more options in the design of the flange. However, since metal conducts heat, deteriorations of the portion made of synthetic material are again found.

One object of the present invention is therefore to propose a pulley in which the design of the flanges makes it possible to reduce or even to remove the risks of damaging the portions of the pulley flanges made of synthetic material as a result of heating, in particular when the belt slips.

Accordingly, the subject of the invention is a pulley for a belt transmission device, notably for a belt speed-variator, the said pulley comprising at least one shaft and two flanges supported by the said shaft, one of the flanges, called the moveable flange, recessed centrally and received so as to fit onto the said shaft, for an axially free installation and, preferably, rotatably secured onto the said shaft, being fitted with return means to return in the direction of the other flange, and delimiting with the other flange a groove of variable dimension inside which it is possible for the said transmission belt to be inserted, at least one of the flanges being a flange made of synthetic material furnished, on its surface facing the other flange, with a metal lining adopting the shape of a centrally recessed dish, characterized in that the or each dish is in direct bearing contact with the flange that it lines, in that this bearing contact is interrupted in the zone adjacent to the central recess and in that, in this zone adjacent to the central recess the dish is separated from the flange that it lines by a free space, called a peripheral space, which, by preventing any direct contact between flange and dish, reduces in the said zone the thermal exchanges between flange and dish in the state in which the dish is assembled to the flange.

It should be noted that, by direct bearing contact, it is understood that the dish is directly in contact with the flange and touches the latter so that it can transmit its heat to it. By virtue of the fact that the dish has, from its outer peripheral edge in the direction of its central recess, a zone in which it is in bearing contact with the surface that it lines followed by a zone in which the said bearing contact is interrupted, the thermal exchanges between dish and flange are controlled. In particular, by virtue of the fact that the bearing contact between flange and dish is interrupted in the zone of the dish adjacent to the central recess, in order to delimit in the said zone a free space between dish and flange forming a volume filled with air, also called an air gap, the thermal exchanges between flange and dish are, in this zone, limited or reduced, or even prevented. Since this zone corresponds to the zone of smallest winding diameter of the belt, and therefore to the portion of the groove of the pulley that is worked on at maximum speed, the risks of damaging the flange by heating are reduced or even removed.

In other words, the presence of a space, also called an air gap between dish and flange limits or prevents the transmission of heat from the dish to the flange and consequently damage to the latter, in particular at maximum speed when maximum heat is given off.

Preferably, the space arranged between dish and flange forming a volume filled with air, also called an air gap, adopts the shape of a circular annular volume communicating with the central recess.

A further subject of the invention is a belt speed-variator of the type comprising at least two pulleys connected together by a belt, at least one of the pulleys being a pulley with variably spaced flanges, characterized in that at least the pulley with variably spaced flanges, preferably the receiving pulley of the variator, is of the aforementioned type.

The invention will be clearly understood on reading the following description of exemplary embodiments, with reference to the appended drawings in which:

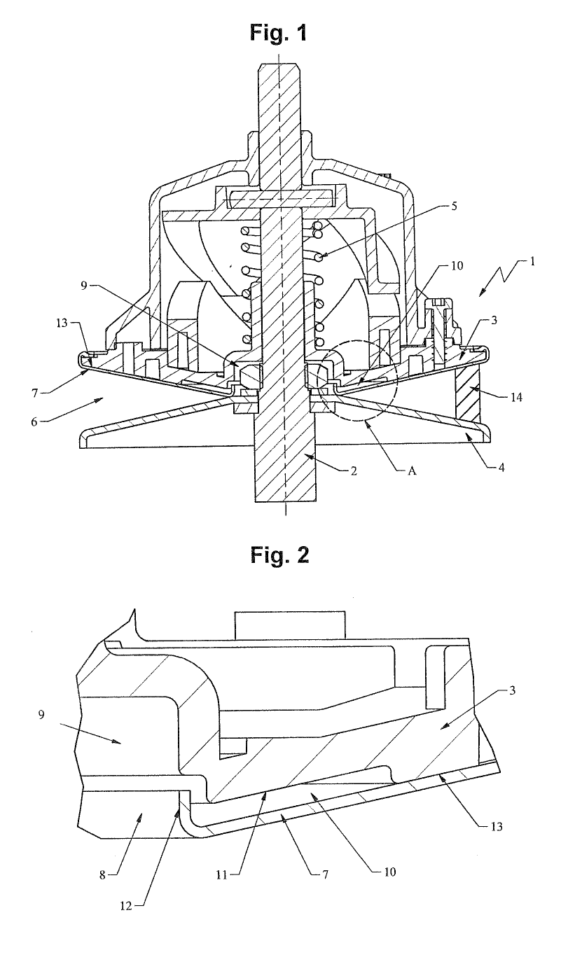

FIG. 1 represents a view in section of pulley according to the invention;

FIG. 2 represents a view of detail A of FIG. 1;

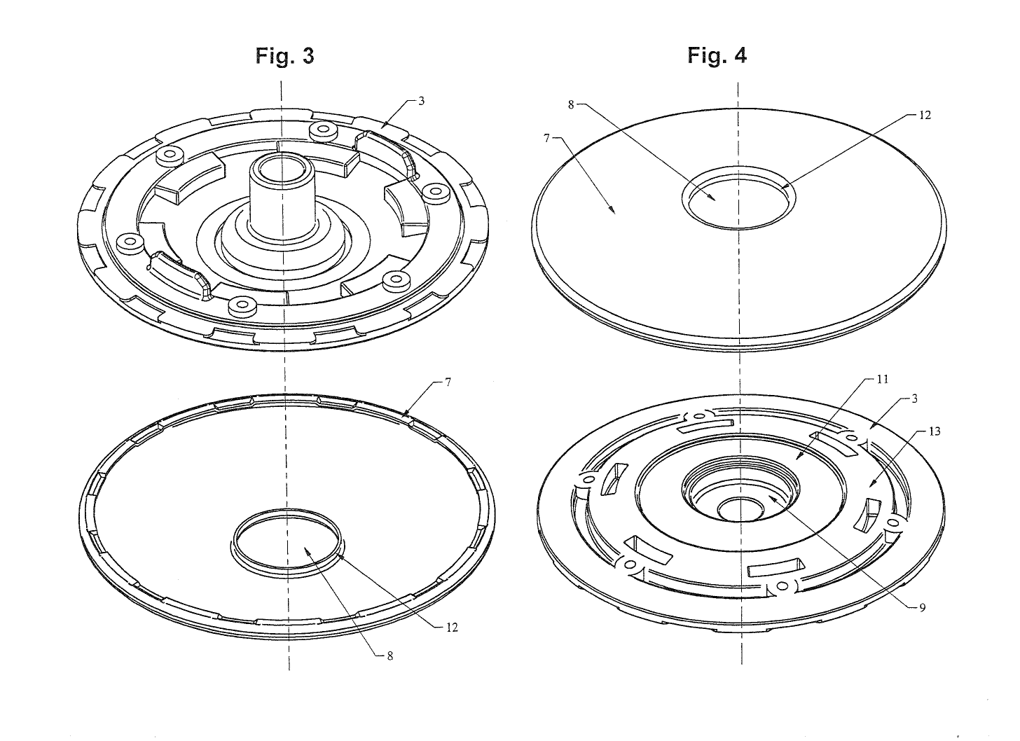

FIG. 3 represents a view in perspective in the exploded position of the flange and its dish, seen on the side of the surface of the flange that is opposite to that facing the other flange;

FIG. 4 represents a view in perspective in the exploded position of the flange and of its dish, seen on the side of the surface of the flange turned towards the other flange.

As mentioned above, the pulley 1, the subject of the invention, is more particularly designed to form the driven or receiving pulley of a belt speed-variator comprising two pulleys with variably spaced flanges connected together by a belt 14. Moving the flanges of a pulley closer together or further apart makes it possible to vary the winding diameter of the belt around the said pulley and consequently the rotation speed of the shaft supporting the flanges of the driven pulley. Such a speed variator can be installed on a self-propelled machine with a driver walking behind the machine, such as a lawnmower, or with an on-board driver, such as a ride-on mower.

This pulley 1 comprises a shaft 2 and two flanges 3, 4 supported by the said shaft 2. In the examples shown, one of the flanges, called the moveable flange, shown as 3 in the figures, is a centrally recessed flange so as to be fitted over the shaft 2 on which it is mounted rotatably fixed but axially free. This movable flange 3 is fitted with return means 5 for returning in the direction of the other flange 4, and delimits, with this other flange 4, a groove 6 of variable dimension inside which the belt 14 of the variator is able to be inserted. The other flange, shown as 4 in the figures, called the fixed flange, is mounted axially fixed and rotatably secured on the supporting shaft 2. Naturally, other configurations of pulley with variably spaced flanges, such as a pulley with two moveable flanges, may also be envisaged. One of the flanges, in this instance the moveable flange 3, is a flange made of synthetic material furnished, on its surface 13 facing the other flange, with a metal lining adopting the shape of a centrally recessed dish 7. The central recesses 8 and 9 of the dish 7 and of the flange 3 make it possible to fit the assembly onto the supporting shaft 2. Naturally, the recessed dish 7 could equally line the fixed flange 4. The dish 7 is kept in bearing contact and covering the surface 13 of the flange that it lines. Preferably, the dish 7 is, in order to be kept in bearing contact with the flange 3 that it lines, crimped onto the said flange 3.

In the examples shown, the moveable flange 3 is formed of a centrally recessed circular plate. The said central recess 9 is furnished with a rim protruding at least on one side of the said plate in order to form a barrel coaxial with the shaft 2 supporting the pulley. The return means 5 for returning the moveable flange 3 in the direction of the fixed flange 4 adopt the shape of a helical spring wound around the said barrel of the moveable flange 3 and of the supporting shaft 2.

The dish forming the lining may take the general form of a truncated cone in order to be adapted to the shape of the surface of the flange that it lines which may also have a generally truncated cone shape.

In a manner characteristic of the invention, the or each dish 7 is, in its zone adjacent to the central recess 8, separated from the flange 3 that it lines by a space 10, called a peripheral space, which, by preventing any direct contact between flange 3 and dish 7, reduces, in the said zone, the thermal exchanges between flange 3 and dish 7.

Preferably, the space 10 arranged between dish 7 and flange 3 adopts the shape of a circular annular volume communicating with the central recess 9.

Generally, the free space 10 is formed in the manner of a facing by a reinforcement 11 or a hollow of the surface 3 of the flange lined with the dish 7, this reinforcement 11 or hollow delimiting, on the said surface 13, an annular cavity around the location occupied by the said bearing shaft 2. This facing may or may not be stepped.

This design is more particularly visible in FIG. 4 which shows a flange furnished with a central recess 9 surrounded by a stepped annular cavity. The first step simply forms a relief in the said flange in order to allow the housing of a nut secured to the supporting shaft 2. This nut is used for fixing and holding the other flange onto the supporting shaft 2. The second step helps to produce the space 10 between dish 7 and flange which makes it possible to reduce the thermal exchanges between dish and flange. At this second step, the open face of the cavity, opposite to the face forming the bottom of the said cavity, is therefore covered by the said dish 7.

The central recess 8 of the or each lining dish 7 is delimited by an internal peripheral rim 12 of the dish 7 forming a stiffener, the said rim 12 preferably extending in the direction of the surface 13 of the flange 3 to be lined.

When the rim 12 extends in the direction of the surface of the flange to be lined, the free edge of this rim does not come into contact with the flange but has the simple function of preventing the dish from bending in this zone when it is acted upon by the belt.

As mentioned above, the dish therefore comes into bearing contact with the surface of the flange facing the other flange, at its outer peripheral edge. This bearing contact is continued in the direction of the central recess of the dish up to a zone close to the central recess and separated from the central recess by a distance equal to approximately ⅓ of the radius of the said flange. Here, the bearing contact is, by virtue of the presence of the indentation or hollow of the surface of the flange, interrupted up to the central recess. The free space 10 therefore forms an annular volume extending over approximately ⅓ of the radius of the said flange.

In the examples shown, the or at least one of the flanges 3, 4 made of synthetic material, furnished on its surface 13 facing the other flange with a metal lining adopting the shape of a centrally recessed dish 7, is the or one of the moveable flanges of the pulley.

Preferably, the pulley 1 comprises two flanges, one 4 fixed, the other 3 moveable, the moveable flange 3 being a flange made of synthetic material furnished on its surface 13 facing the other flange with a metal lining adopting the shape of a centrally recessed dish 7, the fixed flange 4 preferably being made of metal.

As mentioned above, the pulley 1 described above is more particularly designed to form the receiving pulley of a belt speed-variator.

1. Pulley (1) for a belt transmission device, notably for a belt speed-variator, the said pulley (1) comprising at least one shaft (2) and two flanges (3, 4) supported by the said shaft (2), one (3) of the flanges (3, 4), called the moveable flange, recessed centrally and received so as to fit onto the said shaft (2), for an axially free installation and, preferably, rotatably secured onto the said shaft (2), being fitted with return means (5) to return in the direction of the other flange (4), and delimiting with the other flange (4) a groove (6) of variable dimension inside which it is possible for the said transmission belt to be inserted, at least one (3) of the flanges (3, 4) being a flange made of synthetic material furnished, on its surface (13) facing the other flange, with a metal lining adopting the shape of a centrally recessed dish (7),
characterized in that the or each dish (7) is in direct bearing contact with the flange that it lines, in that this bearing contact is interrupted in the zone adjacent to the central recess (8) and in that, in this zone adjacent to the central recess (8) the dish (7) is separated from the flange (3) that it lines by a free space (10), called a peripheral space, which, by preventing any direct contact between flange (3) and dish (7), reduces in the said zone the thermal exchanges between flange (3) and dish (7) in the state in which the dish is assembled to the flange.

2. Pulley (1) according to claim 1, characterized in that the space (10) arranged between dish (7) and flange (3) forming a volume filled with air, also called an air gap, adopts the shape of a circular annular volume communicating with the central recess (8).

3. Pulley (1) according to claim 1, characterized in that the free space (10) is formed in the manner of a facing by a reinforcement (11) or a hollow of the surface (3) of the flange lined with the dish (7), this reinforcement (11) or hollow delimiting, on the said surface (13), an annular cavity around the location occupied by the said bearing shaft (2).

4. Pulley (1) according to claim 1, characterized in that the or at least one of the flanges (3, 4) made of synthetic material, furnished on its surface (13) facing the other flange with a metal lining adopting the shape of a centrally recessed dish (7), is the or one of the mobile flanges of the pulley.

5. Pulley (1) according to claim 1, characterized in that the pulley (1) comprises two flanges, one flange (4) fixed, the other flange (3) moveable, the moveable flange (3) being a flange made of synthetic material furnished on its surface (13) facing the other flange with a metal lining adopting the shape of a centrally recessed dish (7), the fixed flange preferably being made of metal.

6. Pulley (1) according to claim 1, characterized in that the central recess (8) of the or of each lining dish (7) is delimited by an internal peripheral rim (12) of the dish (7) forming a stiffener, the said rim (12) preferably extending in the direction of the surface (13) of the flange (3) to be lined.

7. Pulley (1) according to claim 1, characterized in that the dish (7) is, in order to be kept in bearing contact with the flange (3) that it lines, crimped onto the said flange (3).

8. Belt speed-variator of the type comprising at least two pulleys connected together by a belt, at least one of the pulleys being a pulley with variably spaced flanges, characterized in that at least the pulley with variably spaced flanges, preferably the receiving pulley of the variator, conforms to claim 1.

9. Pulley (1) according to claim 2 characterized in that the free space (10) is formed in the manner of a facing by a reinforcement (11) or a hollow of the surface (3) of the flange lined with the dish (7), this reinforcement (11) or hollow delimiting, on the said surface (13), an annular cavity around the location occupied by the said bearing shaft (2).

10. Pulley (1) according to claim 2 characterized in that the or at least one of the flanges (3, 4) made of synthetic material, furnished on its surface (13) facing the other flange with a metal lining adopting the shape of a centrally recessed dish (7), is the or one of the mobile flanges of the pulley.

11. Pulley (1) according to claim 2 characterized in that the pulley (1) comprises two flanges, one flange (4) fixed, the other flange (3) moveable, the moveable flange (3) being a flange made of synthetic material furnished on its surface (13) facing the other flange with a metal lining adopting the shape of a centrally recessed dish (7), the fixed flange preferably being made of metal.

12. Pulley (1) according to claim 2, characterized in that the central recess (8) of the or of each lining dish (7) is delimited by an internal peripheral rim (12) of the dish (7) forming a stiffener, the said rim (12) preferably extending in the direction of the surface (13) of the flange (3) to be lined.

13. Pulley (1) according to claim 2, characterized in that the dish (7) is, in order to be kept in bearing contact with the flange (3) that it lines, crimped onto the said flange (3).
